(19) United States
(12) Patent Application Publication
(10) Pub. No.: US 2022/0292350 A1
(43) Pub. Date: Sep. 15, 2022

(54) MODEL UPDATING APPARATUS, MODEL UPDATING METHOD, AND MODEL UPDATING PROGRAM

(71) Applicant: TOYOTA JIDOSHA KABUSHIKI KAISHA, Toyota-shi Aichi-ken (JP)

(72) Inventors: Toshihiro Nakamura, Sunto-gun Shizuoka-ken (JP); Daiki Yokoyama, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/689,158

(22) Filed: Mar. 8, 2022

(30) Foreign Application Priority Data
Mar. 15, 2021 (JP) 2021-041487

(51) Int. Cl. G06N 3/08

(52) U.S. Cl. CPC G06N 3/08; B60W 50/00

(57) ABSTRACT

A model updating apparatus updates a machine learning model for outputting a value of an output parameter associated with a device when a value of the input parameter associated with the device is input. The model updating apparatus has a processor, which is configured to: acquire a learning data set used for updating the machine learning model; identify a plurality of model candidates in which at least one of an algorithm and a hyperparameter is different from each other; calculate an estimate accuracy of each of the model candidates, by using the learning data set; and update the machine learning model to a model corresponding to a model candidate with the highest estimation accuracy among the model candidates. The model candidate at the time of a current update identified by the processor includes the model candidate at the time of the previous update having the highest estimation accuracy.

### TECHNICAL FIELD

The present disclosure relates to a model updating apparatus, a model updating method, and a model updating program.

### BACKGROUND

Conventionally, it has been proposed to perform various processes on a device using a machine learning model learned by machine learning or the like (for example, JP 2020-086786 A and WO 2018/173121 A). Such processing includes, for example, detection of an object of a product, detection of an abnormality of a manufactured product, and the like.

For example, in JP2020-086786 A, learning data is created by using a plurality of feature extraction units that extract data relating to features from a data set by a preprocessing unit. The evaluation of the estimation accuracy by the machine learning model created using the learning data is used as the evaluation of the feature extraction unit.

### SUMMARY

In the meantime, in Japanese Patent Application Laid-Open No. 2020-086786, a plurality of feature extraction units having different parameters and the like are used to extract data relating to features. However, with respect to the machine learning model learned by using the data extracted by the feature extraction unit, the algorithm, the hyperparameter, and the like are fixed. Therefore, in the method described in Japanese Patent Application Laid-Open No. 2020-086786, for example, when periodically updating a machine learning model, it is not possible to obtain a machine learning model using an appropriate algorithm or hyperparameter for data relating to a feature, and therefore it is not always possible to obtain a machine learning model with high estimation accuracy.

In view of the above problems, the object of the present disclosure is to provide a model updating apparatus that obtains a machine learning model using an appropriate algorithm or an appropriate hyperparameter.

The gist of the present disclosure is as follows.

(1) A model updating apparatus for updating a machine learning model for outputting a value of an output parameter associated with a device when a value of an input parameter associated with the device is input, the model updating apparatus comprising:

a learning data acquisition unit for acquiring a learning data set used for updating the machine learning model;

a model candidate identification unit for identifying a plurality of model candidates, each of the plurality of model candidates having a different set of an algorithm and a hyperparameter;

an accuracy calculation unit for calculating an estimate accuracy of each of the model candidates, by using the learning data set; and

a model updating unit for updating the machine learning model to a model corresponding to a model candidate with highest estimation accuracy among the model candidates, wherein

the learning data set includes data generated based on a value of the input parameter collected after a previous update of the machine learning model and a value of the output parameter collected after a previous update of the machine learning model, and

the model candidate at a time of a current update identified by the model candidate identification unit includes the model candidate at the time of the previous update having the highest estimation accuracy at the time of the previous update.

(2) The model updating apparatus according to above (1), wherein the model candidates at the time of the current update identified by the model candidate identification unit include a predetermined number of model candidates at the time of the previous update in order from the model candidates having higher estimation accuracy at the time of previous update, and the predetermined number is 2 or more.

(3) The model updating apparatus according to above (1) or (2), wherein the model candidates at the time of the current update identified by the model candidate identification unit include a model in which only a part of the hyperparameter is changed from a predetermined number of models at the time of the previous update in order from the model candidates having higher estimation accuracy at the time of the previous update.

(4) The model updating apparatus according to any one of above (1) to (3), wherein the model updating apparatus updates a machine learning model provided in a server capable of communicating with a plurality of devices and shared by the plurality of devices, and

the learning data set includes data generated based on values of input parameters and output parameters collected in the plurality of devices.

(5) The model updating apparatus according to any one of above (1) to (3), wherein the model updating apparatus is provided in an electronic control unit of one device to update a dedicated machine learning model of the device, and

the learning data set includes data generated based on values of input parameters and output parameters collected in only the one device.

(6) The model updating apparatus according to any one of above (1) to (3), wherein the model updating apparatus is provided in a server capable of communicating with a plurality of devices to update a machine learning model dedicated to each device, and

the learning data set used for updating the machine learning model of each device includes data generated based on values of input parameters and output parameters collected only in the device.

(7) The model updating apparatus according to above (6), wherein the device is a vehicle, and

the model candidate at the time of the current update identified by the model candidate identification unit includes the model candidate at the time of the previous update having the highest estimation accuracy at the time of the previous update in another vehicle.

(8) The model updating apparatus according to above (7), wherein the another vehicle has a driving environment, including at least one of a traveling area of the vehicle, a type of the vehicle, and a cumulative traveling distance of the vehicle, the driving environment of the another vehicle substantially matching a driving environment of the vehicle in which the model should be updated.

(9) A model updating method for updating a machine learning model for outputting a value of an output parameter associated with a device upon inputting a value of an input parameter associated with the device, the model updating method comprising:

acquiring a learning data set used for updating the machine learning model;

identifying a plurality of model candidates, each of the plurality of model candidates having a different set of an algorithm and a hyperparameter;

calculating an estimation accuracy of each of the model candidates, by using the learning data set; and

updating the machine learning model to a model corresponding to a model candidate with highest estimation accuracy among the model candidates, wherein

the learning data set includes data generated based on a value of the input parameter collected after a previous update of the machine learning model and a value of the output parameter collected after a previous update of the machine learning model, and

the model candidate at a time of a current update to be identified includes model candidates at the time of the previous update having the highest estimation accuracy at the time of the previous update.

(10) A model update program for updating a machine learning model for outputting a value of an output parameter associated with a device upon inputting the value of an input parameter associated with the device, the model update program causing a computer to execute a process comprising:

acquiring a learning data set used for updating the machine learning model,

identifying a plurality of model candidates, each of the plurality of model candidates having a different set of an algorithm and a hyperparameter,

calculating an estimation accuracy of each of the model candidates by using the learning data set, and

updating the machine learning model to a model corresponding to a model candidate with highest estimation accuracy among the model candidates, wherein

the learning data set includes data generated based on a value of an input parameter collected after a previous update of the machine learning model and a value of an output parameter collected after a previous update of the machine learning model, and

the model candidate at a time of a current update to be identified includes model candidates at the time of the previous update having the highest estimation accuracy at the time of the previous update.

According to the present disclosure, there is provided a model updating apparatus for obtaining a machine learning model using a suitable algorithm or a suitable hyperparameter.

### BRIEF DESCRIPTION OF THE DRAWINGS

FIG. 1 is a diagram schematically showing a hardware configuration of a vehicle.

FIG. 2 is a functional block diagram of the processor of the vehicle.

FIG. 3 is a diagram showing an example of an NN model having a simple configuration.

FIG. 4 is a diagram schematically showing how the machine learning model is updated by the model updating apparatus.

FIG. 5 is a flowchart illustrating a flow of model update process performed in an ECU of a vehicle.

FIG. 6 is a schematic configuration diagram of a machine learning system according to the second embodiment.

FIG. 7 is a functional block diagram of the processor of the vehicle according to the second embodiment.

FIG. 8 is a diagram illustrating a hardware configuration of a server schematically.

FIG. 9 is a functional block diagram of a processor of the server.

FIG. 10 is an operation sequence diagram showing the flow of the model update process performed by the ECU of the vehicle and the server.

FIG. 11 is an operation sequence diagram showing the flow of the model update process performed by the ECU of the vehicle and the server.

### DETAILED DESCRIPTION

Hereinafter, embodiments will be described in detail with reference to the drawings. In the following description, like components are denoted by the same reference numerals.

### First Embodiment

### Configuration of Vehicles

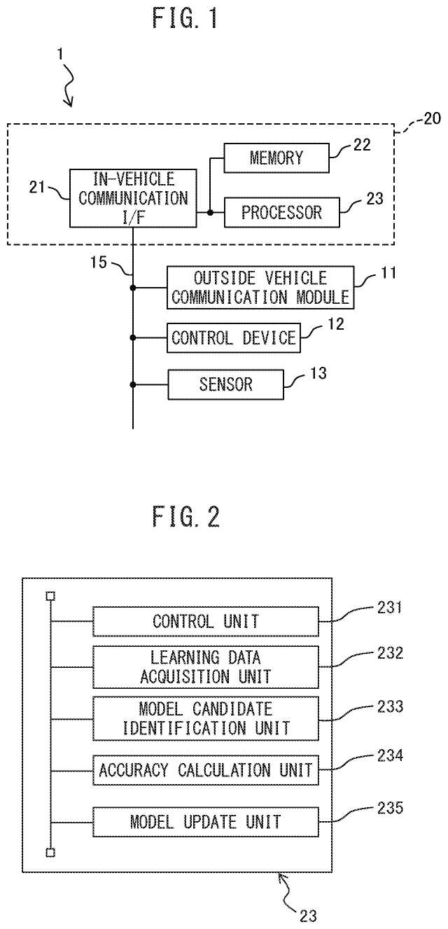

First, with reference to FIGS. 1 and 2, a vehicle 1 equipped with the model updating apparatus according to the first embodiment will be described. The model updating apparatus is a device for updating a machine learning model that outputs a value of an output parameter (target variable) related to the vehicle 1 when a value of an input parameter (explanatory variable) related to the vehicle 1 is input.

FIG. 1 is a diagram schematically showing a hardware configuration of the vehicle 1. As shown in FIG. 1, the vehicle 1 includes an outside vehicle communication module 11, a plurality of control devices 12, a plurality of sensors 13, and an electronic control unit (hereinafter referred to as “ECU”) 20. The outside vehicle communication module 11, the plurality of control devices 12, the plurality of sensors 13 and the ECU 20 are communicatively connected via the in-vehicle network 15. The in-vehicle network 15 is a network that conforms to standards such as CAN (Controller Area Network). The plurality of control devices 12 may be connected to the ECU 20 via signal wires without using CANs.

The outside vehicle communication module 11 is an example of a communication unit that performs communication with an outside vehicle device. The outside vehicle communication module 11 is, for example, a device for communicating with a server or another vehicle. The outside vehicle communication module 11 includes, for example, a data communication module (DCM).

The control device 12 is a device for performing various controls relating to the vehicle 1. Specifically, the control device 12 may include, for example, a drive actuator of a throttle valve for adjusting the opening of the throttle valve of an internal combustion engine, an injector for supplying fuel to a combustion chamber of the internal combustion engine, when the internal combustion engine for driving the vehicle 1 or for generating electrical power is provided in the vehicle 1. Further, the control device 12, for example, when the electric motor for driving the vehicle 1 is provided in the vehicle 1, may include an inverter or the like for controlling the electric motor. Additionally, the control device 12 may include an actuator of a brake, an actuator of a steering system, or the like. Additionally, the control device 12 may include a blower for an air conditioner, a drive actuator for the air mix door that controls the air flow of the air conditioner, and the like. These control devices 12 are actuated in response to a drive signal from the ECU 20.

The sensor 13 is an example of a detection device that detects the values (state quantities) of various state parameters with respect to the vehicle 1. The sensor 13 includes, for example, an air amount sensor for detecting the amount of suction air supplied to the internal combustion engine, an injection pressure sensor for detecting the fuel injection pressure from the injector of the internal combustion engine, an exhaust temperature sensor for detecting the temperature of an exhaust gas, a power sensor for detecting the power supplied to the electric motor, an input detection sensor for detecting the input of the driver in the touch panel or the like, a self position sensor for detecting the self position of the vehicle 1 (e.g., GPS) and the like. Furthermore, the sensor 13 includes, for example, an outside air temperature sensor for detecting the temperature of the air around the vehicle 1 (outside air temperature), such as an in-vehicle temperature sensor for detecting the temperature of the indoor of the vehicle 1 (indoor temperature). These sensors 13 are connected to the ECU 20 via the in-vehicle network 15 and transmit output signals to the ECU 20.

The ECU 20 includes an in-vehicle communication interface 21, a memory 22, and a processor 23. The in-vehicle communication interface 21 and the memory 22 are connected to the processor 23 via signal lines. In the present embodiment, one ECU 20 is provided in the vehicle 1, but a plurality of ECUs separated for each function may be provided in the vehicle 1. In the present embodiment, the ECU 20 functions as a model updating apparatus for updating the machine-learning model.

The in-vehicle communication interface 21 has interface circuits for connecting the ECU 20 to the in-vehicle networks 15. The ECU 20 communicates with other in-vehicle devices via the in-vehicle communication interface 21.

The memory 22 is an example of a storage unit for storing data. The memory 22 includes, for example, a volatile semiconductor memory (e.g., RAM) and a nonvolatile semiconductor memory (e.g., ROM). The memory 22 stores a computer program for executing various processing in the processor 23, various data used when various processing is executed by the processor 23, and the like. Thus, the memory 22 stores a machine learning model.

The processor 23 includes one or a plurality of CPUs (Central Processing Unit) and peripheral circuits thereof. The processor 23 may further comprise GPU (Graphics Processing Unit) or arithmetic circuits such as logical or numerical units. The processor 23 executes various kinds of processing based on a computer program stored in the memory 22. Therefore, when the value of the input parameter of the machine learning model is input, the processor 23 performs arithmetic processing according to the machine learning model, and outputs the value of the output parameter.

FIG. 2 is a functional block diagram of the processor 23 of the vehicle 1. As shown in FIG. 2, the processor 23 includes a control unit 231 for controlling the control device 12 of the vehicle 1 using the machine learning model, a learning data acquisition unit 232 for acquiring a learning data set used for updating the machine learning model, a model candidate identification unit 233 for identifying a plurality of model candidates in which at least one of the algorithm and the hyperparameter is different from each other, an accuracy calculation unit 234 for calculating the estimation accuracy of each of the model candidates using the learning data set, and a model update unit 235 for updating a new machine learning model to a model corresponding to the model candidate with the highest estimation accuracy among the model candidates. The functional blocks of the processor 23 are, for example, functional modules implemented by computer programs running on the processor 23. Alternatively, the functional blocks included in the processor 23 may be dedicated arithmetic circuits provided in the processor 23. Details of the functional blocks of the processor 23 of the vehicle 1 will be described later.

### Machine-Learning Model

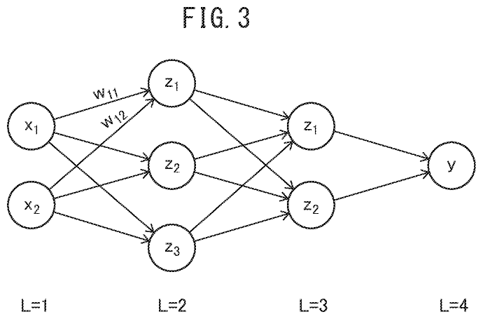

In the present embodiment, in the control unit 231 of the vehicle 1, when controlling the control device 12 mounted on the vehicle 1, a machine learning model that is machine-learned is used. In the present embodiment, for example, a neural network model (hereinafter referred to as “NN model”) is used as the machine learning model. Hereinafter, an outline of the NN model will be described with reference to FIG. 3. FIG. 3 shows an example of an NN model having a simple configuration.

The circles in FIG. 3 represent artificial neurons. Artificial neurons are usually referred to as nodes or units (referred to herein as “nodes”). In FIG. 3, L=1 denotes an input layer, L=2 and L=3 denote a hidden layer (or intermediate layer), and L=4 denotes an output layer.

In FIG. 3, x₁ and x₂ indicate nodes of the input layer (L=1) and the output values from the nodes, and y indicates the node of the output layer (L=4) and the output value thereof. Similarly, z₁^{(L=2)}, z₂^{(L=2)}, and z₃^{(L=2)} indicate output values from each node and nodes of the hidden layer (L=2), and z₁^{(L=3)} and z₂^{(L=3)} indicate output values from each node and nodes of the hidden layer (L=3).

Input is output as is at each node of the input layer. On the other hand, the output values x₁ and x₂ of the respective nodes of the input layer are input to the respective nodes of the hidden layer (L=2), and the total input value u is calculated by using the corresponding weights w and biases b in the respective nodes of the hidden layer (L=2). For example, the total input value uₖ(L=2) calculated in each node represented by zₖ^{(L=2)} (k=1, 2, 3) of the hidden layer (L=2) in FIG. 3 is expressed by the following equation (M is the number of nodes of the input layer).

$${u}_{k}^{( L = 2 )} = {\sum }_{m = 1}^{M} ( {x}_{m} \cdot {w}_{k m}^{( L = 2 )} ) + {b}_{k}$$

This total input value uk(L=2) is then transformed by the activation function f and output as an output value zₖ^{(L=2)} (=f(uk(L=2))) from the node indicated by zₖ^{(L=2)} of the hidden layer (L=2). On the other hand, the output values z₁^{(L=2)}, z₂^{(L=2)} and z₃^{(L=2)} of the respective nodes of the hidden layer (L=2) are input to the respective nodes of the hidden layer (L=3), and the total input value u(=Σz·w+b) is calculated using the corresponding weights w and biases b in the respective nodes of the hidden layer (L=3). The total input value u is similarly converted by an activation function, and output from each node of the hidden layer (L=3) as output values z₁^{(L=3)} and z₂^{(L=3)}. The activation function is, for example, ReLU function σ.

The output values z₁^{(L=3)} and z₂^{(L=3)} of the respective nodes of the hidden layer (L=3) are input to the nodes of the output layer (L=4), and the total input value u (Σz·w+b) is calculated using the corresponding weights w and biases b, at the nodes of the output layer. For example, a sigmoid function or an identity function is used as an activation function in a node of the output layer. In this case, the total input value u calculated at the node of the output layer is directly output from the node of the output layer as the output value y.

Thus, the NN model includes an input layer, a hidden layer, and an output layer, and when one or more input parameters are input from the input layer, one or more output parameters corresponding to the input parameters are output from the output layer.

In the present embodiment, as such a machine learning model, a model, which outputs the temperature of the exhausted air as the value of the output parameter when, for example, the outside air temperature, the amount of the intake air, the fuel injection amount, the fuel injection timing, the fuel injection pressure, and the like are input as the values of the input parameters, is used. In the control unit 231 of the vehicle 1, when the value of each input parameter detected by the sensor 13 is input to such a machine learning model, the temperature of the exhaust gas is output. The control unit 231 based on the temperature of the output exhaust gas, and controls the control device 12 relating to the internal combustion engine. Here, since there is a response delay in the exhaust temperature sensor for detecting the temperature of the exhaust gas, it was not always possible to appropriately control the internal combustion engine when performing the control of the internal combustion engine based on the output of the exhaust temperature sensor. On the other hand, since there is no delay in the calculation of the temperature of the exhaust gas using the machine learning model, the internal combustion engine can be more appropriately controlled by controlling the internal combustion engine using the temperature of the exhaust gas calculated by the machine learning model.

As the machine learning model, a model having various input parameters and output parameters related to the vehicle can be used. For example, the input parameters may include at least one of a variety of state parameters representing the state of the vehicle, such as the amount of intake air, intake air temperature, fuel injection pressure, fuel injection timing, fuel injection amount, air-fuel ratio, ignition timing, engine cooling water temperature, supercharge pressure, outside air temperature, outside air humidity, atmospheric pressure, indoor temperature, indoor humidity, and the amount of sunlight to the vehicle. The output parameter includes at least one of various state parameters representing the state of the vehicle, such as the temperature of the exhaust purification catalyst, the concentration of NOx in the exhaust gas, the engine output torque, and the in-vehicle humidity.

In performing the machine learning of the NN model as described above, a learning data set generated based on the value of the state parameter indicating the state of the vehicle is used. The status parameter includes an output value of the sensor 13 provided in the vehicle 1 and/or a control command value from the ECU 20 to the control device 12. The learning data set is generated based on a combination of a plurality of measured values of a plurality of input parameters and a plurality of measured values (truth data) of at least one output parameter corresponding to the measured values. In the present embodiment, a learning data set is generated by performing preprocessing (preprocess of missing values, normalization, standardization, etc.) on the data of the output value of the sensor 13 and the control command value.

In machine learning of the NN model, for example, the weights w and the biases b in the NN model are repeatedly updated by the well-known error back-propagation method so that the difference between the output value of the NN model and the correct value of the output parameter included in the learning data set becomes small. As a result, the NN model is learned, and a learned NN model is generated. In this specification, parameters whose values are updated by learning, for example, the weight w and the bias b, are referred to as learning parameters.

### Algorithms and Hyperparameters of the Machine Learning Model

In the meantime, the NN model shown in FIG. 3 as an example, includes two hidden layers, and the number of nodes of these hidden layers is three and two, respectively. In the NN model as described above, the configuration of the model changes according to the number of such hidden layers and the number of nodes in each hidden layer. In the examples shown in FIG. 3, ReLU function is used as the activation function in the intermediate layers, but the configuration of the models changes according to the activation function used in the nodes. Such activation functions include, for example, a tan h function, a sigmoidal function, and a LeakyReLU function. In addition, the configuration of the models changes according to the type of regularization term (e.g., Adam) to be added to the loss-function, the presence or absence of normalization (e.g., batch-normalization), the presence or absence of dropouts, the dropout rate, etc. The parameters that change the configuration of these models are called hyperparameters and are distinguished from the learning parameters described above, which are determined within the framework of inference.

In the example described above, a fully connected NN model is used as the machine learning model. However, as the machine learning algorithm, neural networks other than the fully connected neural networks such as a convolutional neural network (CNN) and a recurrent neural network (RNN) may be used. As the machine learning algorithm, for example, an algorithm other than a neural network (NN), such as a support vector machine (SVM), a decision tree (DT), and a random forest, may be used. Hyperparameters exist for each machine learning algorithm. For example, hyperparameters of the SVM include the type of the kernel function, y of the RBF kernel function, the regularization coefficient C, the insensitivity coefficient £, and the like.

The estimation accuracy by the machine learning model varies according to such algorithms and hyperparameters. Also, for each problem or situation, the optimal algorithm and hyperparameters are different. Therefore, for example, the optimal algorithm and hyperparameters in the model for estimating the temperature of the exhaust gas described above are not always optimal in other problems. In addition, the optimal algorithm and hyperparameters in the model for estimating the temperature of the exhaust gas when the exhaust purification catalyst is new are not necessarily optimal even in the model for estimating the temperature of the exhaust gas when the exhaust purification catalyst deteriorates. Therefore, in order to increase the estimation accuracy by the machine learning model, it is necessary to select the optimal algorithm and hyperparameters for each problem and situation.

### Summary of Model-Update Process

Therefore, in the present embodiment, when the vehicle 1 is manufactured, algorithm and hyperparameters optimal for the estimation process (e.g., estimation process of the temperature of the exhaust gas) are identified. In addition, in the present embodiment, even after the manufacture of the vehicle 1, algorithm and the hyperparameters are updated periodically to be optimal for the estimation process.

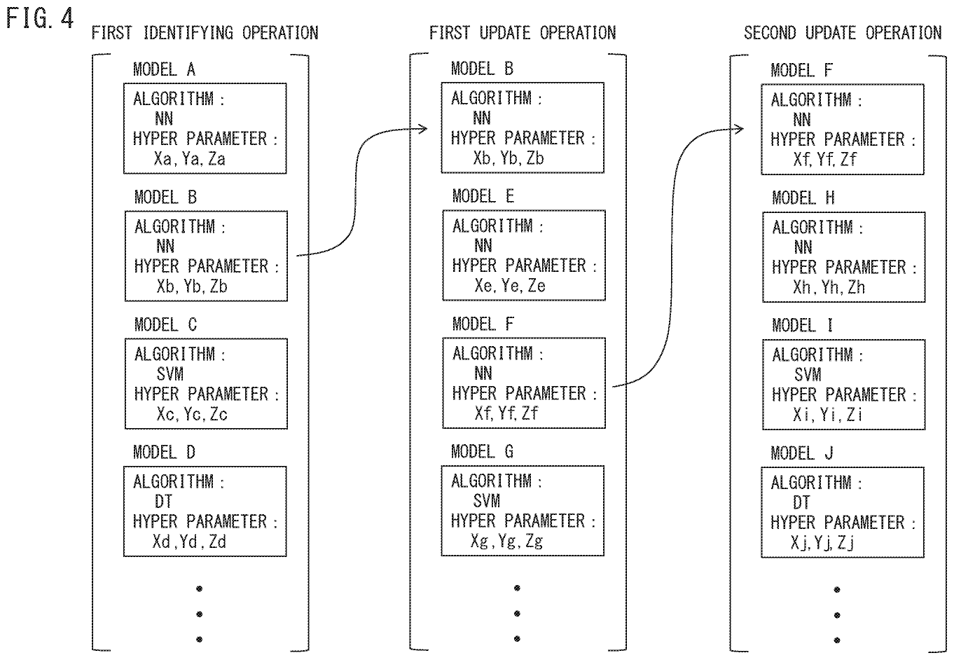

FIG. 4 is a diagram schematically showing how the machine learning model is updated by the model updating apparatus according to the present embodiment. FIG. 4 schematically shows the first identifying operation of the model, the first update operation of the model, and the second update operation of the model. The first identifying operation is performed, for example, in the manufacturing stage of the vehicle 1, and the updating operation is performed, for example, after the vehicle is shipped.

In the example shown in FIG. 4, in the first identifying operation, a plurality of models including the models A to D are identified as candidates. Identification of model candidates in the first identification operation is performed by an arbitrary search method. Specifically, the model candidate is identified by, for example, a random search, a Bayesian search, or the like. In the example shown in FIG. 4, the model A has an algorithm of a neural network (NN) and hyperparameters of Xa, Ya, and Za. Model B is a model that uses the same algorithm as Model A and has different hyperparameters from Model A. Models C and D are models that differ from Model A in both algorithm and hyperparameter.

In the first identifying operation, all of these candidate models are learned, i.e., trained and verified, using the learning dataset. As a result of the model validation, the model candidates with the highest estimation accuracy are identified as the machine learning model used in the vehicle 1. In the example shown in FIG. 4, in the first particular operation, the model B with the highest estimation accuracy is identified as the machine learning model used in the vehicle 1.

When a predetermined period of time has elapsed since the first identifying operation, the first update operation is performed. In the first update operation, the model candidate is first identified as in the first identification operation. As shown in FIG. 4, in the first update operation, the model B, which is the model with the highest estimation accuracy in the first identifying operation (that is, the previous update operation), is identified as the model candidate. In addition, a model different from the model B in at least one of the algorithm and the hyperparameter is identified as a candidate. Specifically, the model candidate is identified by, for example, a random search, a Bayesian search, or the like on the assumption that the model B has already been identified as the model candidate. In the example shown in FIG. 4, models E-G have been identified as different model candidates from model B in the first update operation.

In the first update operation, all the models of these candidates are trained and verified using the learning data set. The learning data set includes data generated based on the values of input parameters and output parameters collected after the first identifying operation (i.e., the previous update operation). Then, the machine learning model used in the vehicle 1 is updated to the model candidate with the highest estimation accuracy as a result of the verification of the model. In the example shown in FIG. 4, in the first update operation, the machine learning model used in the vehicle 1 is updated to the model F with the highest estimation accuracy.

The second and subsequent update operations are performed in the same manner as the first update operation. Therefore, the second and subsequent update operations are performed after a predetermined period of time has elapsed since the previous update operation. In each update operation, first, as in the first update operation, a model candidate including the model having the highest accuracy in the previous update operation is identified. Once model candidates are identified, training and verification of the model is performed using the learning dataset. Then, the machine learning model used in the vehicle 1 is updated to the model candidate with the highest estimation accuracy as a result of the verification of the model.

### Flow of Model Update Process

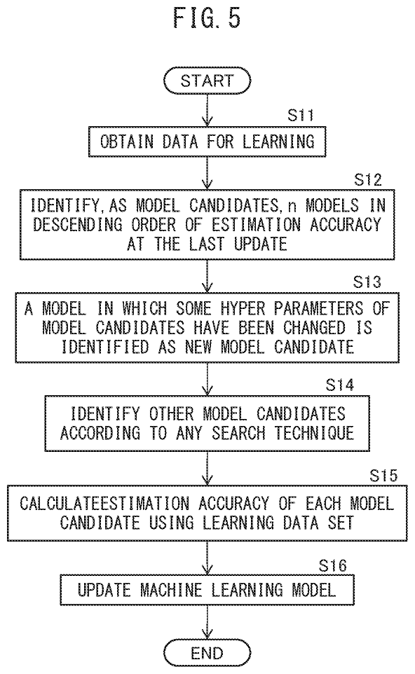

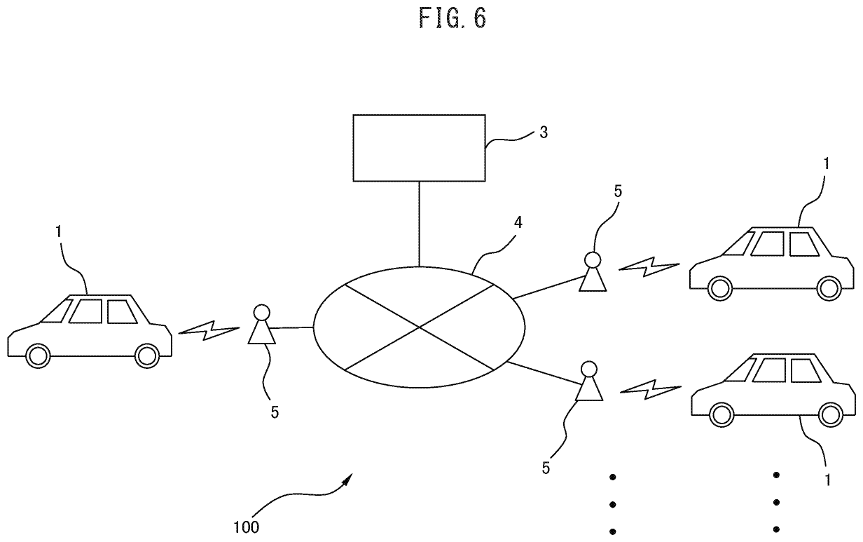

FIG. 5 is a flowchart illustrating a flow of a model update process performed in the ECU 20 of the vehicle 1. The model update process shown in the figure is executed every preset period. Specifically, the model update process is executed when a predetermined time has elapsed since the previous update processing, when the vehicle 1 has traveled a predetermined travel distance since the previous update processing, or when a learning data set including a predetermined amount of data has been generated from the previous update processing, or the like.

In the model update process, first, a learning data set used for updating the machine learning model is acquired by the learning data acquisition unit 232 (Step S11). The learning data set is generated by the ECU 20 based on, for example, the output value of the sensor 13 and the data of the control command value to the control device 12. That is, the learning data set is generated based on the measured values of the input parameters and the measured values of the output parameters. Thus, the learning data set comprises data generated on the basis of the values of the input parameters and the values of the output parameters collected only in this vehicle 1. In particular, in the present embodiment, the learning data set includes data generated based on the values of the input parameters and the output parameters collected after the previous update processing.

In the machine learning model for estimating the temperature of the exhaust gas described above, the learning data set is generated based on the output value of the sensor 13 for detecting the outside air temperature, the intake air amount, the fuel injection pressure, the temperature of the exhaust gas, and the like, and the control command value to the control device 12 (the fuel injection valve) for the fuel injection amount, the fuel injection timing. In particular, in the present embodiment, the learning data set is generated by performing preprocessing (preprocess of missing values, normalization, standardization, etc.) on the data of the output value of the sensor 13 or the control command value to the control device 12.

When the learning data set is acquired, the model candidate identification unit 233 identifies, as model candidates, n models in order from the model with higher estimation accuracy in the previous update processing (Step S12). That is, in the present embodiment, the model candidates at the time of the current update processing include n models (a predetermined number of model candidates at the time of the previous update processing) in descending order of the estimation accuracy at the time of the previous update processing. n is an integer of 1 or more, and may be 2 or more, or 10 or more. In any case, since n is 1 or more, the model candidate at the time of the current update processing includes the model having the highest estimation accuracy at the time of the previous update processing.

Next, the model candidate identification unit 233 identified, as a new model candidate, a model in which only a part of the hyperparameters are changed from among the model candidates identified in step S12 (Step S13). To be more generalized, in the present embodiment, the model candidates at the time of the current update processing include a model in which only a part of the hyperparameters is changed from n models (which may be the same as or different from n, but is preferable n or less) in order from the model with higher estimation accuracy at the time of the previous update processing. Specifically, for example, the number of hidden layers of the NN model, the number of nodes of each hidden layer, and the like are changed. The number of hyperparameters to be changed may be a small number, e.g. 10 or less.

Next, the model candidate identification unit 233 identifies model candidates different from the model candidate identified in steps S12 and S13 according to a predetermined search method (Step S14). As such a search method, for example, a random search, a Bayesian search, or the like is used (since the next model candidate is identified by using the estimation accuracy of each model candidate calculated in step S15 described later when performing the Bayesian search, steps S14 and S15 are alternately repeated). In the identification of the model candidate in step S14, not only the hyperparameter but also the model whose algorithm has been changed from the existing model candidate are identified as new model candidates.

When the model candidates are identified in steps S12 to S14, the estimation accuracy is calculated for all the identified model candidates using the learning data set acquired in step S11 (step S15). Specifically, the learning data set is divided into a training data set and a verification data set, and learning parameters such as weights and biases are trained using the training data set for each model candidate. The verification data set is then used to calculate the estimated accuracy for each trained model candidate. Alternatively, the combination of the training certificate data set and the verification data set may be changed a plurality of times, and training and verification may be performed each time the combination is changed.

When the estimation accuracy is calculated for all the model candidates, the machine learning model dedicated to the vehicle 1 used in the control unit 231 of the ECU 20 is updated to the model having the highest estimation accuracy in Step S15 (Step S16). As a result, the machine learning model used in the control unit 231 is updated to a model with high estimation accuracy.

In the example shown in FIG. 5, after the learning data acquisition unit 232 acquires the learning data set in Step S11, the model candidates are identified by the model candidate identification unit 233 in Steps S12 to S14. However, the identification of the model candidate may be performed simultaneously with the acquisition of the learning data set, or may be performed before the acquisition of the learning data set.

In addition, the model candidate identification unit 233 identifies the model candidates by three different methods in steps S12 to S14. However, the model candidate identification unit 233 does not have to execute steps S12 and S13 to execute step S14, and does not have to execute steps S12 and S14 to execute step S13.

### Action and Effect

According to the model updating apparatus of the present embodiment, the machine learning model is periodically updated using the learning data set created based on the data collected after the previous update processing. Therefore, it is possible to control the control device 12 using a machine learning model using an appropriate algorithm and appropriate hyperparameters according to the current situation of the vehicle 1.

In addition, according to the model updating apparatus of the present embodiment, at the time of the update processing, a model having a high estimation accuracy in the previous update processing is added to the model candidate. In addition, in the present embodiment, a model in which only a part of the hyperparameters is changed from the model in which the estimation accuracy was high in the previous update process is also added to the model candidate. Therefore, model candidates include models whose estimation accuracy is expected to be high, so that model candidates with high estimation accuracy can be identified in a short search time. As a result, it is possible to finally obtain a machine learning model using a more appropriate algorithm and a more appropriate hyperparameter in a short search time.

### Second Embodiment

Next, with reference to FIGS. 6 to 10, a machine learning system 100 including the model updating apparatus according to the second embodiment will be described. In the present embodiment, the model updating apparatus is provided with vehicles 1 and a server 3 capable of communicating with the plurality of vehicles 1, updates the machine learning model shared by the plurality of vehicles. In the following, the model updating apparatus according to the second embodiment will be mainly described with respect to portions different from the model updating apparatus according to the first embodiment.

FIG. 6 is a schematic configuration diagram of a machine learning system 100 according to the second embodiment. As shown in FIG. 6, the machine learning system 100 includes a plurality of communicable vehicles 1 and a server 3. Each of the plurality of vehicles 1 and the server 3 is configured to be able to communicate with each other via a communication network 4 configured by an optical communication line or the like and a radio base station 5 connected to the communication network 4 via a gateway (not shown). The communication between the vehicle 1 and the radio base station 5 is based on an arbitrary communication standard. In the present embodiment, the outside vehicle communication module 11 of the vehicle 1 communicates with the server 3 via the radio base station 5 and the communication network 4.

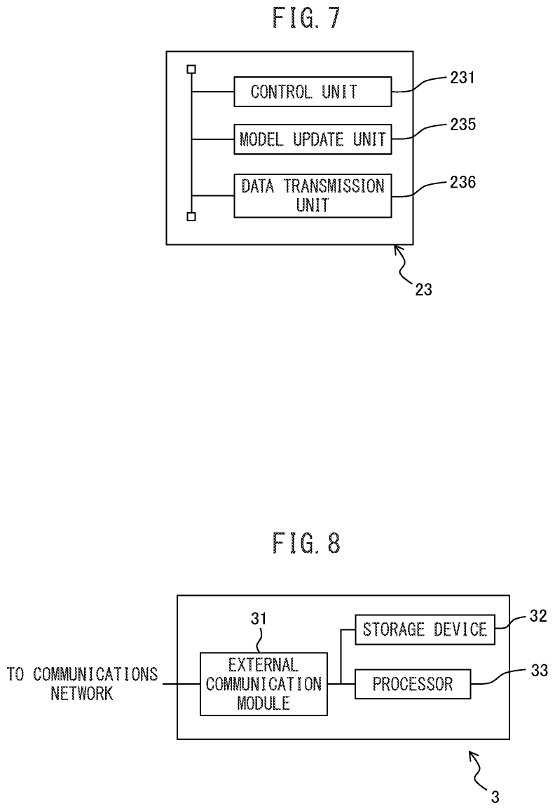

FIG. 7 is a functional block diagram of the processor 23 of the vehicle 1 according to the second embodiment. As shown in FIG. 7, the processor 23 includes a control unit 231, a model update unit 235, and a data transmission unit 236 for transmitting data to the server 3. In particular, in the present embodiment, the data transmission unit 236 transmits the output value of the sensor 13 and the control command value to the control device 12, which are used for creating the learning data set, to the server. Alternatively, the data transmit unit 236 may transmit the learning data set generated in the ECU 20 of the vehicle 1 to the server. In the present embodiment, the processor 23 of the vehicle 1 functions as a part of a model updating apparatus for updating the machine learning model.

FIG. 8 is a diagram illustrating a hardware configuration of the server 3 schematically. The server 3 includes an external communication module 31, a storage device 32, and a processor 33, as illustrated in FIG. 8. The server 3 may include an input device such as a keyboard and a mouse, and an output device such as a display.

The external communication module 31 is an example of a communication unit for communicating with a device outside the server 3. The external communication module 31 includes an interface circuit for connecting the server 3 to the communication network 4. The external communication module 31 is configured to be able to communicate with each of the plurality of vehicles 1 via the communication network 4 and the radio base station 5.

The storage device 32 is an example of a storage unit for storing data. The storage device 32 includes, for example, a hard disk drive (HDD), a solid state drive (SSD), or an optical recording medium. The storage device 32 stores a computer program for executing various processing by the processor 33 and various data used when various processing is executed by the processor 33.

The processor 33 has one or a plurality of CPUs and peripheral circuits thereof. The processor 33 may further comprise a GPU or an arithmetic circuit such as a logical unit or a numerical unit. The processor 33 executes various kinds of processing based on a computer program stored in the storage device 32. In this embodiment, the processor 33 of the server 3 also functions as part of a model updating apparatus that updates the machine learning model.

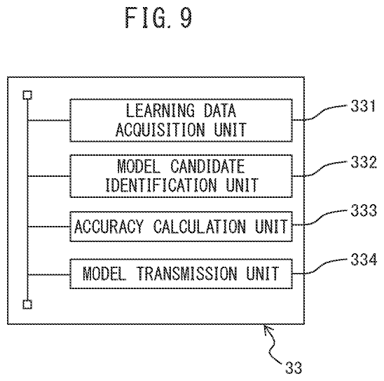

FIG. 9 is a functional block diagram of a processor 33 of the server 3. As shown in FIG. 9, the processor 33 includes a learning data acquisition unit 331 for acquiring learning data used for updating the machine learning model, a model candidate identification unit 332 for identifying a plurality of model candidates in which at least one of the algorithm and the hyperparameter is different from each other, an accuracy calculation unit 333 for calculating the estimation accuracy of each of the model candidates using the learning data, and a model transmission unit 334 for transmitting the model candidate with the highest estimation accuracy among the model candidates to the vehicle 1 as a model for updating. These functional blocks of the processor 33 are functional modules implemented, for example, by computer programs running on the processor 33. Alternatively, the functional blocks included in the processor 33 may be dedicated arithmetic circuits provided in the processor 33. Details of each function block of the processor 33 of the server 3 will be described later.

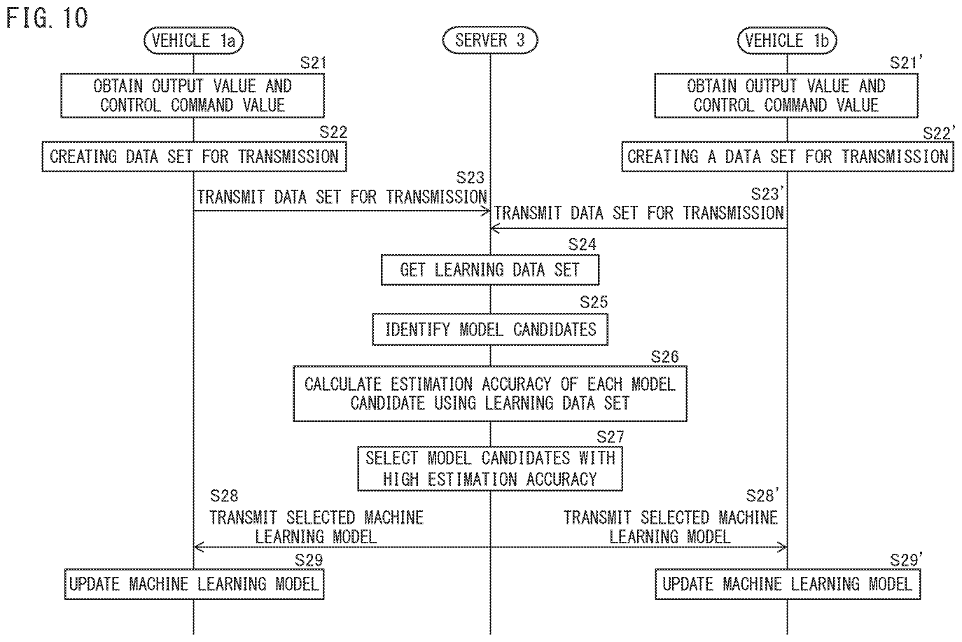

FIG. 10 is an operation sequence diagram showing the flow of the model update process performed by the ECU 20 of the vehicle 1 and the server 3. In the example shown in FIG. 10, a common machine learning model used in the vehicle 1a and the vehicle 1b is updated.

In the model update process in the present embodiment, as shown in FIG. 10, the ECU 20 of the vehicle 1a, while the operation of the vehicle 1a, acquires the data of the output value from the sensor 13, also obtains the data of the control command value from the ECU 20 to the control device 12 (Step S21). The same processing is performed in the other vehicle 1b communicating with the server 3 (Step S21′).

In each vehicle 1a and 1b, when the data of the output value of the sensor 13 and the control command value to the control device 12 is obtained to some extent, the ECU 20 of the vehicle 1a and the vehicle 1b creates a transmission data set based on these data (Steps S22, S22′). For example, the ECU 20 generates a transmission data set by preprocessing the data acquired in step S21 and S21′. When the transmission data set is generated, the data transmission unit 236 of the vehicles 1a and 1b transmits the generated transmission data set to the server 3 via the radio base station 5 and the communication network 4 (Steps S23, S23′).

The learning data acquisition unit 331 of the server 3 acquires a collection of transmission data sets transmitted from the plurality of vehicles 1a and 1b as a learning data set (Step S24). Therefore, in the present embodiment, the learning data set includes data generated based on the values of the input and output parameters collected by the plurality of vehicles.

In the present embodiment, the generation of the transmitting data set by the preprocessing is performed by the ECU 20 of each of the vehicles 1a and 1b. However, each of the vehicles 1a and 1b may transmit data of the output value of the sensor 13 and the control command value to the control device 12 to the server 3 without preprocessing. In this case, the processor of the server 3 generates a learning data set by preprocessing the data received from each of the vehicles 1a and 1b.

When the learning data acquisition unit 331 acquires the learning data set, the model candidate identification unit 332 identifies the model candidate (Step S25). The model candidate identification unit 332 of the present embodiment identifies a model candidate similarly to the model candidate identification unit 233 of the first embodiment. Therefore, the model candidate identification unit 332 identifies, as model candidates, n models in order from the model candidates having the highest estimation accuracy in the previous update processing, identifies a model in which only a part of the hyperparameters among the n model candidates are changed as new model candidates, and identifies model candidates different from the model candidates already identified according to a predetermined search method.

When the model candidates are identified, the accuracy calculation unit 333 calculates, similarly to step S15, the estimation accuracy of all the identified model candidates using the learning data set acquired in step S24 (Step S26). When the estimation accuracy is calculated for all the model candidates, in Step S27, the model transmission unit 334 selects the model candidates having the highest estimation accuracy among them. Then, the model transmission unit 334 transmits the machine learning model corresponding to the selected model candidate (specifically, the model configuration such as the algorithm, the value of the hyperparameter and the value of the learning parameter) to each of the vehicles 1a and 1b via the communication network 4 and the radio base station 5 (S28, S28′).

Upon receiving the machine learning model from the server 3, the model update unit 235 of the vehicles 1a and 1b updates the machine learning model used in the control unit 231 of the ECU 20 to the machine learning model transmitted from the server 3 (Steps S29 and S29′). As a result, the machine learning model used in the control unit 231 is updated to a model with higher estimation accuracy.

According to the model updating apparatus according to the present embodiment, since the calculation of the estimation accuracy for the model candidates having the large calculation load is performed by the server 3, the calculation load of the ECU 20 of the vehicle 1 can be reduced.

In the example shown in FIG. 10, the server 3 creates learning data based on data from two vehicles 1a and 1b. However, the server 3 may create learning data based on data from three or more vehicles. In the example shown in FIG. 10, the server 3 transmits the data of the common update machine learning model to the two vehicles 1a and 1b. However, the server 3 may transmit data of the update machine learning model common to three or more vehicles. However, in the present embodiment, the plurality of vehicles 1 sharing the machine learning model may be in a similar driving environment, for example. Therefore, for example, the plurality of vehicles 1 sharing the machine learning model may have the same vehicle type, the same shipping time, the same degree of cumulative traveling distance, and the same area as the main traveling area.

### Third Embodiment

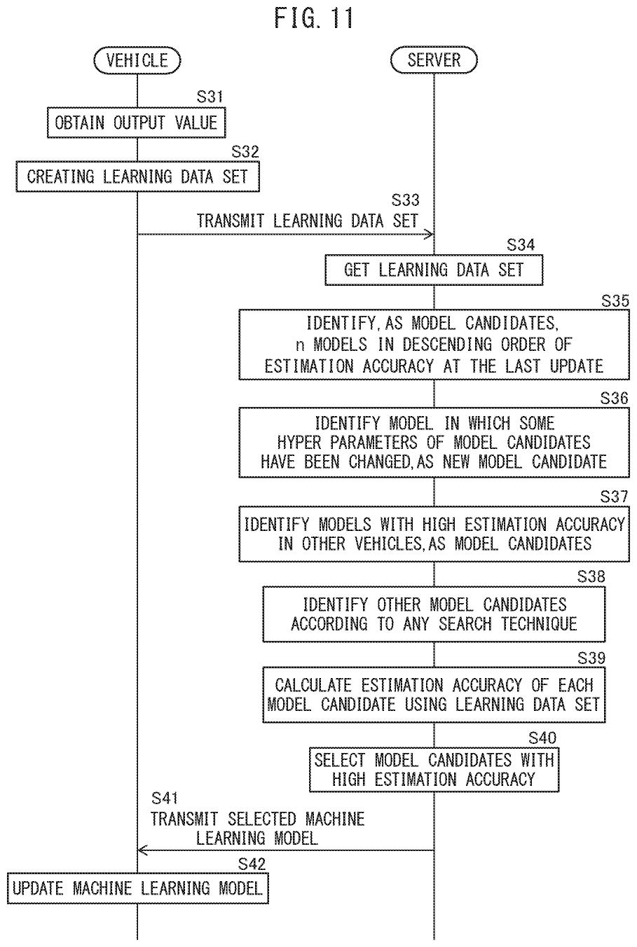

Next, with reference to FIG. 11, a machine learning system 100 including the model updating apparatus according to the third embodiment will be described. In the present embodiment, a model updating apparatus for updating a machine learning model specific to each vehicle 1 is provided in a server 3 capable of communicating with the plurality of vehicles 1 and the vehicle 1. Hereinafter, the model updating apparatus according to the third embodiment will be described focusing on portions different from the model updating apparatus according to the first embodiment and the second embodiment.

The machine learning system 100 according to the present embodiment has the same configuration as the machine learning system 100 according to the second embodiment. Accordingly, the machine learning system 100 includes a vehicle 1 and a server 3 capable of communicating with the vehicle 1. On the other hand, in the present embodiment, the server 3 updates the machine learning model dedicated to the vehicle 1 using the learning data set transmitted from each vehicle 1.

FIG. 11 is an operation sequence diagram showing the ECU 20 of the vehicle 1 and the flow of the model update process performed by the server 3. In the example shown in FIG. 11, the dedicated machine learning model of the vehicle 1 is updated.

In the model update process in the present embodiment, the ECU 20 of the vehicle 1, similarly to step S21 and S21′ of FIG. 10, obtains the data of the output value from the sensor 13, also obtains the data of the control command value from the ECU 20 to the control device 12 (Step S31). The ECU 20 generates a learning data set based on the acquired data, for example, by performing pre-processing (Step S32). Accordingly, the learning data set includes data generated based on the values of the input parameters and the values of the output parameters collected only in this vehicle. When the learning data set is generated, the data transmission unit 236 of the vehicle 1 transmits the generated learning data set to the server 3 (Step S33). Incidentally, the data transmission unit 236 of the vehicle 1 may transmit the data of the output value from the sensor 13 and the control command value to the control device 12, to the server 3. In this case, the learning data set is generated in the server 3 based on the transmitted data.

The learning data acquisition unit 331 of the server 3 acquires the learning data set transmitted from the vehicle 1 (Step S34). When the learning data set is acquired, the model candidate identification unit 332 of the server 3 identified, as model candidates, n models in order from the one where the estimation accuracy was highest at the time of the previous update processing, similarly to step S12 of FIG. 5 (Step S35). Next, as in step S13 of FIG. 5, models in which only some of the hyperparameters are changed among the n model candidates are identified as new model candidates (Step S36).

In addition, in the present embodiment, the model candidate identification unit 332 identifies, as a new model candidate, a model having the highest estimation accuracy at the time of the previous update processing in other vehicles in which the update processing of the machine learning model is performed in the server 3 (Step S37). Other vehicles may be vehicles having the same main traveling area as, vehicles of the same type as, vehicles having a similar sipping time to, and vehicles having a similar cumulative travel distance to, the vehicle 1 in which the model thereof should be updated. That is, other vehicles may be vehicles having substantially the same driving environment as the vehicle 1 in which the model thereof should be updated, the driving environment including at least one of the travel area of the vehicle, the vehicle type and the cumulative travel distance of the vehicle. The model candidate identification unit 332 identifies a model candidate different from the model candidate already identified according to the predetermined search method, similarly to step S14 in FIG. 5 (Step S38).

When the model candidates are identified, similarly to Step S15, the accuracy calculation unit 333 calculates the estimation accuracy using the learning data sets acquired in Steps S35 to S38 for all the identified model candidates (Step S39). Here, the learning data set used for updating the machine learning model of each vehicle is composed of data generated on the basis of the values of the input parameters and the values of the output parameters collected in the vehicle. When the estimation accuracy is calculated for all the model candidates, the model transmission unit 334 selects the model candidate having the highest estimation accuracy and transmits the selected model candidate to the vehicle 1 that has transmitted the data set (Steps S40 and S41). When the model update unit of the vehicle 1 receives the machine learning model from the server 3, the model update unit updates the machine learning model used in the control unit 231 to the machine learning model transmitted from the server 3 (Step S42).

According to the model updating apparatus according to the present embodiment, since the calculation of the estimation accuracy is performed by the server 3, it is possible to reduce the calculation load of the ECU 20 of the vehicle 1. Further, since the model candidates with high estimation accuracy are selected for each vehicle 1 in the server 3, the vehicle 1 can control the control device 12 using a machine learning model using an appropriate algorithm and an appropriate hyperparameter according to the current situation of the vehicle 1.

While embodiments of the present disclosure have been described above, the present disclosure is not limited to these embodiments, and various modifications and changes may be made within the scope of the appended claims.

For example, in the embodiment described above, the model updating apparatus is used to update the machine learning model of the vehicle 1. However, the model updating apparatus may be used for updating the machine learning model used for processing related to devices other than the vehicle, such as, for example, industrial machinery.

1. A model updating apparatus for updating a machine learning model for outputting a value of an output parameter associated with a device when a value of an input parameter associated with the device is input, the model updating apparatus comprising a processor, wherein
the processor is configured to:
acquire a learning data set used for updating the machine learning model;
identify a plurality of model candidates, each of the plurality of model candidates having a different set of an algorithm and a hyperparameter;
calculate an estimate accuracy of each of the model candidates, by using the learning data set; and
update the machine learning model to a model corresponding to a model candidate with highest estimation accuracy among the model candidates, wherein
the learning data set includes data generated based on a value of the input parameter collected after a previous update of the machine learning model and a value of the output parameter collected after a previous update of the machine learning model, and
the model candidate at a time of a current update identified by the processor includes the model candidate at the time of the previous update having the highest estimation accuracy at the time of the previous update.

2. The model updating apparatus according to claim 1, wherein the model candidates at the time of the current update identified by the processor include a predetermined number of model candidates at the time of the previous update in order from the model candidates having higher estimation accuracy at the time of previous update, and the predetermined number is 2 or more.

3. The model updating apparatus according to claim 1, wherein the model candidates at the time of the current update identified by the processor include a model in which only a part of the hyperparameter is changed from a predetermined number of models at the time of the previous update in order from the model candidates having higher estimation accuracy at the time of the previous update.

4. The model updating apparatus according to claim 1, wherein the model updating apparatus updates a machine learning model provided in a server capable of communicating with a plurality of devices and shared by the plurality of devices, and
the learning data set includes data generated based on values of input parameters and output parameters collected in the plurality of devices.

5. The model updating apparatus according to claim 1, wherein the model updating apparatus is provided in an electronic control unit of one device to update a dedicated machine learning model of the device, and
the learning data set includes data generated based on values of input parameters and output parameters collected in only the one device.

6. The model updating apparatus according to claim 1, wherein the model updating apparatus is provided in a server capable of communicating with a plurality of devices to update a machine learning model dedicated to each device, and
the learning data set used for updating the machine learning model of each device includes data generated based on values of input parameters and output parameters collected only in the device.

7. The model updating apparatus according to claim 6, wherein the device is a vehicle, and
the model candidate at the time of the current update identified by the processor includes the model candidate at the time of the previous update having the highest estimation accuracy at the time of the previous update in another vehicle.

8. The model updating apparatus according to claim 7, wherein the another vehicle has a driving environment including at least one of a traveling area of the vehicle, a type of the vehicle, and a cumulative traveling distance of the vehicle, the driving environment of the another vehicle substantially matching a driving environment of the vehicle in which the model should be updated.

9. A model updating method for updating a machine learning model for outputting a value of an output parameter associated with a device upon inputting a value of an input parameter associated with the device, the model updating method comprising:
acquiring a learning data set used for updating the machine learning model;
identifying a plurality of model candidates, each of the plurality of model candidates having a different set of an algorithm and a hyperparameter;
calculating an estimation accuracy of each of the model candidates, by using the learning data set; and
updating the machine learning model to a model corresponding to a model candidate with highest estimation accuracy among the model candidates, wherein
the learning data set includes data generated based on a value of the input parameter collected after a previous update of the machine learning model and a value of the output parameter collected after a previous update of the machine learning model, and
the model candidate at a time of a current update to be identified includes model candidates at the time of the previous update having the highest estimation accuracy at the time of the previous update.

10. A non-transitory computer readable medium having recorded thereon a model update program for updating a machine learning model for outputting a value of an output parameter associated with a device upon inputting the value of an input parameter associated with the device, the model update program causing a computer to execute a process comprising:
acquiring a learning data set used for updating the machine learning model,
identifying a plurality of model candidates, each of the plurality of model candidates having a different set of an algorithm and a hyperparameter,
calculating an estimation accuracy of each of the model candidates by using the learning data set, and
updating the machine learning model to a model corresponding to a model candidate with highest estimation accuracy among the model candidates, wherein
the learning data set includes data generated based on a value of an input parameter collected after a previous update of the machine learning model and a value of an output parameter collected after a previous update of the machine learning model, and
the model candidate at a time of a current update to be identified includes model candidates at the time of the previous update having the highest estimation accuracy at the time of the previous update.
